(19) United States
(12) Patent Application Publication
(10) Pub. No.: US 2025/0202530 A1
(43) Pub. Date: Jun. 19, 2025

(54) APPLICATION IDENTIFIER (AID) ROUTING AND AMBIGUITY RESOLUTION VIA A CONTACTLESS MULTIPLEXER

(71) Applicant: Apple Inc., Cupertino, CA (US)

(72) Inventors: Jean-Marc PADOVA, San Francisco, CA (US); Aurelien P. RABOISSON, San Diego, CA (US); Li LI, Los Altos, CA (US); Ngabin S. NG, San Diego, CA (US)

(21) Appl. No.: 18/886,079

(22) Filed: Sep. 16, 2024

Related U.S. Application Data
(60) Provisional application No. 63/609,815, filed on Dec. 13, 2023.

(51) Int. Cl. H04B 5/40; H04B 5/77; H04W 8/18

(52) U.S. Cl. CPC H04B 5/40; H04B 5/77; H04W 8/18

(57) ABSTRACT

This application sets forth techniques for application identifier (AID) routing and ambiguity resolution via a contactless multiplexer of a wireless device, including determining a target application associated with an AID value, from multiple available applications that share the identical AID value, and routing near-field communication (NFC) communication to the determined target application.

### CROSS-REFERENCE TO RELATED APPLICATIONS

The present application claims the benefit of U.S. Provisional Application No. 63/609,815, entitled “APPLICATION IDENTIFIER (AID) ROUTING AND AMBIGUITY RESOLUTION VIA A CONTACTLESS MULTIPLEXER,” filed Dec. 13, 2023, the content of which is incorporated by reference herein in its entirety for all purposes.

### FIELD

The described embodiments set forth techniques for application identifier (AID) routing and ambiguity resolution via a contactless multiplexer of a wireless device, including determining a target application associated with an AID value, from multiple available applications that share the identical AID value, and routing near-field communication (NFC) communication to the determined target application.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a non-volatile memory (NVM), where the NVM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices.

A wireless device can further include hardware and software for near-field communication (NFC) to allow for contactless operations, such as for electronic payment, building access, or vehicle entry. Applications installed in a secure processor of the wireless device can assist with authorization to perform actions of a contactless operation. An application can be addressed by an external NFC reader using an application identifier (AID) value. Multiple applications installed in one or more secure processors of the wireless device can share a common AID value, resulting in ambiguity as to which application to route communication from the external reader. There exists a need for mechanisms to manage multiple applications with redundant AID values across one or more secure processors of a wireless device.

### SUMMARY

This application sets forth techniques for application identifier (AID) routing and ambiguity resolution via a contactless multiplexer of a wireless device, including determining a target application associated with an AID value, from multiple available applications that share the identical AID value, and routing near-field communication (NFC) communication to the determined target application. A contactless multiplexer, included in an NFC processor of the wireless device, identifies an ambiguity for routing a message from an external NFC reader based on an AID registry. The AID registry includes AID values for one or more applications installed in one or more secure processors of the wireless device and additional logical data for each AID value to assist with resolving to which application one or more messages from the external NFC reader should be routed. The additional logical data for an AID value included in the AID registry can include an indication of a secure processor on which the associated application is installed. In some embodiments, the additional logical data for an AID value can include a unique identifier for an electronic subscriber identity module (eSIM) profile in which the application associated with the AID value is included. In some embodiments, the wireless device includes a first secure processor, e.g., a secure element (SE), on which one or more applications are installed, and each application on the SE are distinguishable from each other based on their respective AID values. In some embodiments, when installing a new application to the SE, the AID value of the new application is adjusted, if required, to differ from AID values for other applications installed in the SE. In some embodiments, the wireless device includes a second secure processor, e.g., an embedded universal integrated circuit card (eUICC) on which one or more eSIM profiles are installed, where each eSIM profile can include one or more applications with respective AID values. In some embodiments, AID values for applications within an eSIM profile can be uniquely identified by their AID value. In some embodiments, AID values for applications in different eSIM profiles can use the same AID value. In some embodiments, AID values for an application in an eSIM profile can be identical to an AID value of an application installed in the SE.

An applications processor (AP) of the wireless device can maintain and manage a set of routing rules associated with different applications available for NFC communication usage on the SE and within one or more eSIMs on the eUICC of the wireless device. The contactless multiplexer can monitor communication from an external NFC reader and determine, based on the AID registry, that at least two distinct applications of the wireless device are associated with an AID value indicated in communication from the NFC reader. The contactless multiplexer can send to the AP of the wireless device a request message to determine which particular application of the at least two distinct applications of the wireless device to use for communication with the NFC reader. The AP can use the set of routing rules to disambiguate between the at least two distinct applications, e.g., based on a current location of the wireless device, a particular application can be selected for use. The AP can respond to the contactless multiplexer indicating the selected particular application, and the contactless multiplexer can send to a secure processor associated with the selected particular application communication from the NFC reader, e.g., to initiate a contactless transaction between the particular application in the secure processor and the NFC reader.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3A illustrates a block diagram of an exemplary near-field communication (NFC) architecture for a wireless device having a single secure processor, according to some embodiments.

FIG. 3B illustrates a block diagram of an exemplary NFC architecture for a wireless device having multiple secure processors, according to some embodiments.

FIGS. 4A and 4B illustrate an exemplary set of actions to resolve an AID ambiguity for an access use-case, according to some embodiments.

FIGS. 5A and 5B illustrate exemplary methods to resolve an AID ambiguity by a contactless multiplexer and an applications processor, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This application sets forth techniques for application identifier (AID) routing and ambiguity resolution via a contactless multiplexer of a wireless device, including determining a target application associated with an AID value, from multiple available applications that share the identical AID value, and routing near-field communication (NFC) communication to the determined target application. A contactless multiplexer, included in an NFC processor of the wireless device, identifies an ambiguity for routing a message from an external NFC reader based on an AID registry. The AID registry includes AID values for one or more applications installed in one or more secure processors of the wireless device and additional logical data for each AID value to assist with resolving to which application one or more messages from the external NFC reader should be routed. The additional logical data for an AID value included in the AID registry can include an indication of a secure processor on which the associated application is installed. In some embodiments, the additional logical data for an AID value can include a unique identifier for an electronic subscriber identity module (eSIM) profile in which the application associated with the AID value is included. In some embodiments, the AID registry includes AID values for one or more applications that can participate in NFC communication, such as for an NFC transaction, with an external NFC reader. In some embodiments, the AID registry allows for determining a target application to initiate to participate in an NFC transaction.

In some embodiments, the wireless device includes a first secure processor, e.g., a secure element (SE), on which one or more applications are installed, and each application on the SE are distinguishable from each other based on their respective AID values. In some embodiments, when installing a new application to the SE, the AID value of the new application is adjusted, if required, to differ from AID values for other applications installed in the SE. In some embodiments, an applications processor (AP) of the wireless device manages installing of applications on the SE and filters out a potential duplicate AID value during installation of an application on the SE. In some embodiments, the wireless device includes a second secure processor, e.g., an embedded universal integrated circuit card (eUICC) on which one or more eSIM profiles are installed, where each eSIM profile can include one or more applications with respective AID values. In some embodiments, AID values for applications within an eSIM profile can be uniquely identified by their AID value. In some embodiments, AID values for applications in different eSIM profiles can use the same AID value. In some embodiments, AID values for an application in an eSIM profile can be identical to an AID value of an application installed in the SE. In some embodiments, an eSIM profile included an eSIM bound profile package (BPP) downloaded from a mobile network operator (MNO) provisioning server can include one or more applications with AID values that overlap with AID values of other applications in eSIM profiles on the eUICC or overlap with AID values of applications in the SE.

An applications processor (AP) of the wireless device can maintain and manage a set of routing rules associated with different applications available for NFC communication usage on the SE and within one or more eSIMs on the eUICC of the wireless device. The contactless multiplexer can monitor communication from an external NFC reader and determine, based on the AID registry, that at least two distinct applications of the wireless device are associated with an AID value indicated in communication from the NFC reader. The contactless multiplexer can send to the AP of the wireless device a request message to determine which particular application of the at least two distinct applications of the wireless device to use for communication with the NFC reader. The AP can use the set of routing rules to disambiguate between the at least two distinct applications, e.g., based on a current location of the wireless device, a particular application can be selected for use. In some embodiments, a particular application having an associated AID value can be pre-assigned to be used at a particular location. For example, a first application can be assigned to be used to access a building at a work location. In addition, a different application, which can have the same AID value, can be pre-assigned to be used at a second location. For example a second application can be assigned to be used to access a building or unit at a home location. The AP can respond to the contactless multiplexer indicating the selected or pre-assigned particular application to be used for the NFC communication with the NFC reader. The contactless multiplexer can send to a secure processor associated with the selected or pre-assigned particular application communication from the NFC reader, e.g., to initiate a contactless transaction between the particular application in the secure processor and the NFC reader.

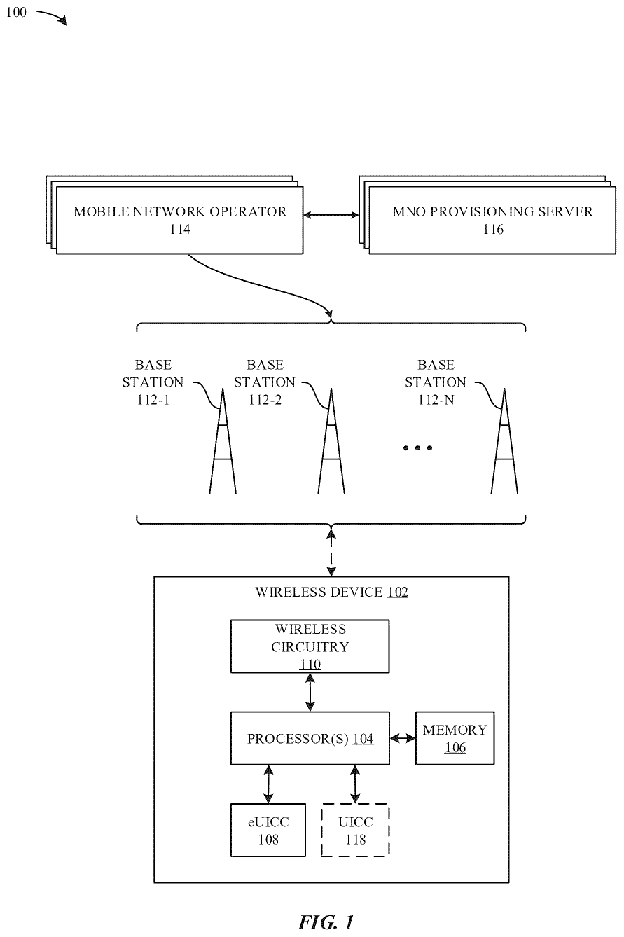

These and other embodiments are discussed below with reference to FIGS. 1-6; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a wireless device, a wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The wireless device 102 can represent a computing device (e.g., an iPhone® or an iPad® by Apple®), the base stations 112-1 to 112-n can represent cellular wireless network entities including evolved NodeBs (eNodeBs or eNBs) and/or next generation NodeBs (gNodeBs or gNB) that are configured to communicate with the wireless device 102, and the MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108, and a baseband wireless circuitry 110 used for transmission and reception of cellular wireless radio frequency signals. The eUICC 108 is one form of a secure processor that can be included in the wireless device 102. In some embodiments, the wireless device 102 can include a separate secure processor, referred to as a secure element (SE) or embedded secure element (eSE) in addition to the eUICC 108. The baseband wireless circuitry 110 can include analog hardware components, such as antennas and amplifiers, as well as digital processing components, such as signal processors (and/or general/limited purpose processors) and associated memory. In some embodiments, the processing circuitry includes one or more physical UICCs 118, also referred to as Subscriber Identity Module (SIM) cards, in addition to or substituting for the eUICC 108. In some embodiments, the processing circuitry includes one or more UICCs 118 that are integrated (iUICCs) securely within at least one of the one or more processors 104 and/or the baseband wireless circuitry 110. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO 114, an eSIM can be reserved for subsequent download and installation to the eUICC 108. In some embodiments, the eUICC 108 obtains one or more eSIMs from one or more associated provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

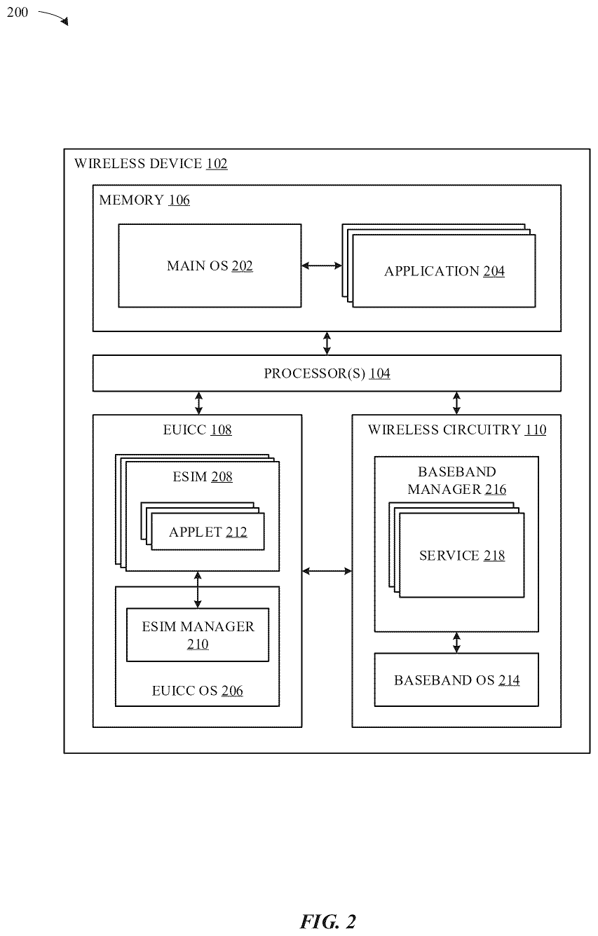

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applications, also referred to as applets 212, which define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102. Applets 212 can be identified by application identifier (AID) values. An applet 212 within an eSIM profile 208 can be uniquely identified from other applets 212 by its associated AID value; however, applets 212 in different eSIM profiles 208 can share the same AID value, in some embodiments. An application in an SE, separate from the eUICC 108, can be uniquely identified by its associated AID value from other applications in the SE; however, an applet 212 in an eSIM profile 208 on an eUICC 108 of the wireless device 102 in which the SE is installed can share the same AID value. As discussed further herein, communication from an external device, such as an external NFC reader, can specific an application for use by an AID value alone, which can result in an ambiguity as to which application to use when multiple applications in different secure processors of the wireless device 102 share the AID value indicated by the communication from the external device.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

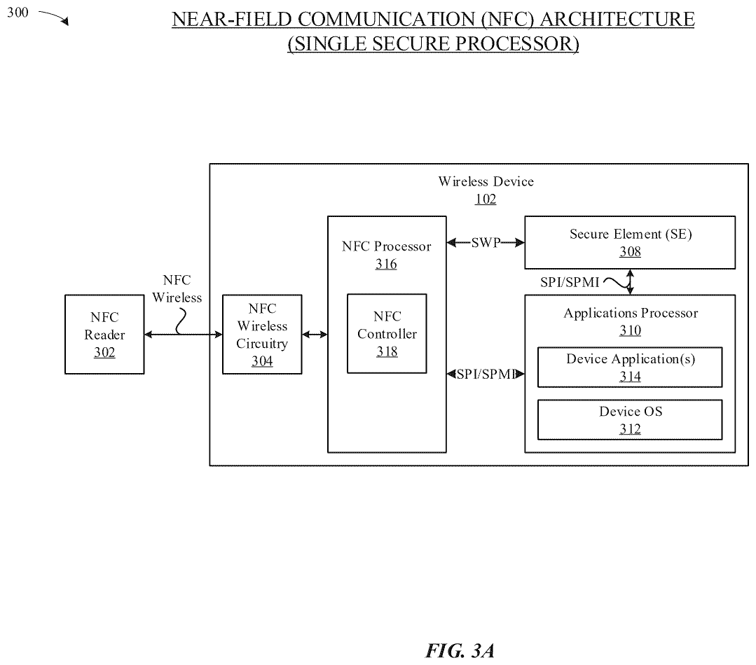

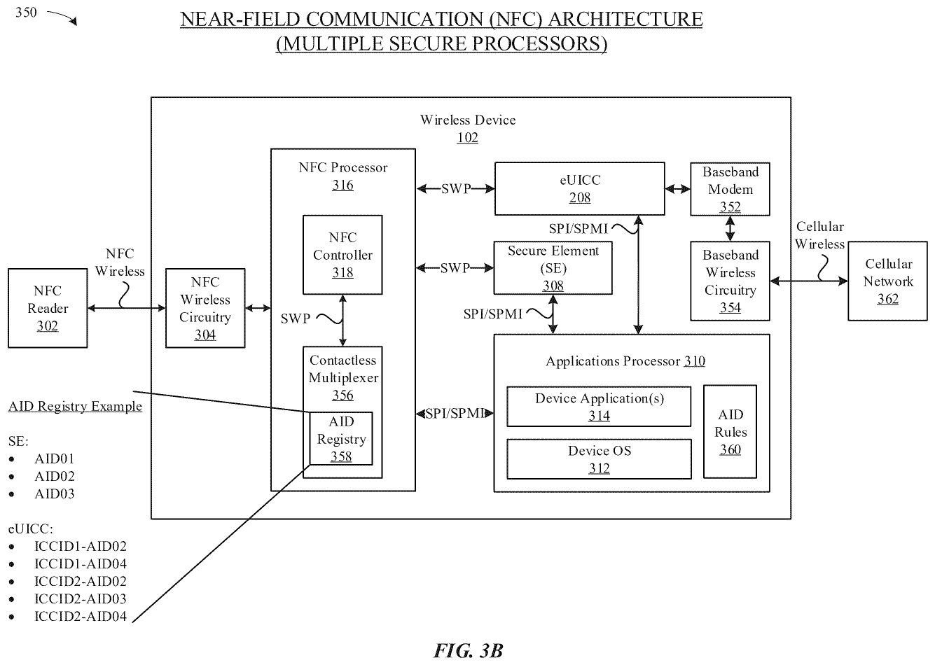

FIG. 3A illustrates a block diagram 300 of an exemplary NFC architecture for a wireless device 102 having a single secure processor. The wireless device 102 includes NFC wireless circuitry 304, such as one or more antennas, connected to an NFC processor 316 that manages NFC communication for the wireless device 102. The NFC processor 316 can include an NFC controller 318 that routes NFC communication between the NFC reader 302, via the NFC wireless circuitry 304, and additional processing elements of the wireless device 102, e.g., a secure element (SE) 308 and an applications processor (AP) 310. The SE 308 can include credentials for authentication to indicate authorization to perform a contactless transaction initiated by the NFC reader 302 responsive to a user action, e.g., tapping the wireless device 102 on the NFC reader 302 or performing a pre-determined action on the wireless device 102, e.g., double pressing a button of the wireless device 102, while in proximity to the NFC reader 302. The SE 308 can include one or applications (also referred to as applets) each application identified by an AID value. When installing a new application on the SE 308, the NFC controller 318 of the NFC processor 316 can ensure that all applications installed on the SE 308 have unique AID values. The NFC reader 302 can specify a particular application with which to communicate on the wireless device 102 by sending, to the wireless device 102 via the NFC wireless circuitry 304, an “open” command that includes the AID value associated with the particular application. Different applications on the SE 308 can be installed to provide different contactless operations for the wireless device 102. For example, the SE 308 can include an application for electronic payment associated with a particular debit card, credit card, or electronic currency account. The SE 308 can include another application for access to an enterprise building (work location) or to an apartment building (home location). The SE 308 can assist with authorization to allow for payment or for access. As different applications in the SE 308 can be uniquely identified by their respective AID value, communication from the NFC reader 302 can be appropriately routed by the NFC controller to the SE 308 and to an applicable application resident on the SE 308.

The wireless device 102 can also include an AP 310 that includes a device operating system (OS) 312 and one or more device applications 314. In some embodiments, a device application 314, such as an electronic wallet application, can interact with the NFC controller 318 and with the SE 308 as part of a contactless operation. In some embodiments, the AP 310 identifies and manages an overlap of AID values when installing a new application to the SE 308 to ensure uniqueness of AID values associated with the different applications installed on the SE 308. A wireless device 102 with multiple secure processors, however, requires additional functionality to handle situations in which AID values of applications, installed in different secure processors of the wireless device, conflict with each other.

FIG. 3B illustrates a diagram 350 of an exemplary NFC architecture for a wireless device 102 with multiple secure processors. The wireless device 102 includes a first secure processor, the SE 308, and a second secure processor, the eUICC 108. The eUICC 108 includes credentials and applications (applets 212), e.g., within one or more eSIM profiles 208, to access cellular wireless services of a cellular network 362 via a baseband modem 352 and baseband wireless circuitry 354. An eSIM profile 208 on the eUICC 108 can also include credentials and applications (applets 212) for access to NFC communication with an external NFC reader 302 via the NFC processor 316 and NFC wireless circuitry 304. The AP 310 includes a set of AID rules 360 to use for resolving conflicts when there is an ambiguity regarding which application to be used for communication from an external NFC reader 302, where the NFC reader 302 identifies the application only by an AID value, and multiple applications on the wireless device 102 can be associated with an identical AID value. Applications stored in the SE 308 and in the eUICC 108 can be further identified by extended AID values that include additional logical data, e.g., an indication of the particular secure processor on which the application is stored. A contactless multiplexer 356 resident on the NFC processor 316 can maintain an AID registry 358 that includes the extended AID values for the applications resident on the various secure processors, e.g., on the eUICC 108 and the SE 308. In some embodiments, the AID registry 358 includes extended AID values for applications that can be used to communicate via the NFC processor 316 and NFC wireless circuitry 304 with an external NFC reader 302.

The NFC controller 318 and the AP 310 can refer to individual applications uniquely using the extended AID values. In some embodiments, an extended AID value for an application includes an AID value for the application and an identifier for the secure processor on which the application is resident. In some embodiments, an extended AID value for an application includes a unique identifier value for an eSIM profile 208 in which the application is included, e.g., an international circuit card identifier (ICCID) value for the eSIM profile 208. AID values within the SE 308 can be unique. In some embodiments, when installing an application on the SE 308 potential duplicate AID values can be identified and filtered out. AID values within an individual eSIM profile 208 can be unique; however, AID values of applications in different eSIM profiles 208 or in an eSIM profile and in the SE 308 can overlap. Extended AID values, however, can be unique across all applications relevant for NFC communication in the SE 308 and in eSIM profiles 208 of the eUICC 108.

Applications included in an eSIM profile 208 can be associated with AID values when installing the eSIM profile 208, e.g., when downloaded from an MNO provisioning server 116, such as an SM-DP+, in an eSIM bound profile package (BPP). An MNO 114 can update an eSIM profile 208 installed on the eUICC 108 using an over-the-air (OTA) procedure. An MNO 114 can also provision a new eSIM profile 208 to the eUICC 108, where the new eSIM profile 208 includes applications having AID values that overlap with applications already in other eSIM profiles 208 on the eUICC 108 or on the SE 308. An identical AID value can be used for an application in the SE 308 and for another application in an eSIM profile 208 on the eUICC 108. Similarly, an identical AID value can be used for an application in a first eSIM profile 208 on the eUICC 108 and for another application in a second eSIM profile 208 on the eUICC 108. As described herein, redundant AID values can be disambiguated using the AID registry 358, and which particular application to use with an NFC reader 302 can be based on AID rules 360 managed and maintained by the AP 310.

An exemplary AID registry 358 is indicated in FIG. 3B. The SE 308 includes three different applications identified by AID values AID01, AID02, and AID3. The eUICC 108 includes applications in two different eSIM profiles 208, the first eSIM 208 identified by ICCID01 and the second eSIM 208 identified by ICCID02. The first eSIM 208 includes two different applications available for NFC communication use identified by AID values AID02 and AID04. The second eSIM 208 includes three different applications for NFC communication use identified by AID values AID02, AID03, and AID04. The application across the SE 308 and the eUICC 108 can be uniquely identified using extended AID values that include a secure processor identifier, e.g., SE or eUICC, and for those applications on the eUICC 108, ICCID values for the eSIM profiles 208 in which the applications are included, e.g., ICCID1 or ICCID2. For example, the three different applications that share the same AID value, AID02, can be distinguished uniquely by using extended AID values of: i) SE: AID02, for the application on the SE 308, ii) eUICC:ICCID1-AID02, for the application included in the first eSIM profile 208 on the eUICC 108, and iii) eUICC:ICCID2-AID02, for the application included in the second eSIM profile 208 on the eUICC 108.

Device applications 314 on the AP 310, such as a digital wallet application, can refer to a particular application uniquely using an associated extended AID value. A device application 314 and/or the device OS 312 can manage and maintain the AID rules 360 that determine which application should be used under various circumstances. In some embodiments, the AID rules 360 include location information, e.g., a current location of the wireless device 102 can be used to select a particular application to use. For example, an AID rule can associate a first access application with a work location, and another AID rule can associate a second access application with a home location. Both the first access application and the second access application can have the same AID value but distinct extended AID values. The first access application can be installed in a first secure processor, e.g., the SE 308, while the second access application can be installed in a second secure processor, e.g., the eUICC 108. When an external NFC reader 302 requests to open an access application by using the shared AID value, the contactless multiplexer 356 can identify an ambiguity exists regarding which application to use based on the AID registry 358. The contactless multiplexer 356 can request the AP 310 to determine, using the AID rules 360, which of the applications to use. The contactless multiplexer 356 can refer to the multiple applications that have a common AID value by using the extended AID values. The AP 310 can select a particular application from the multiple applications based on the AID rules 360 and provide an indication of the selected particular application to the contactless multiplexer 356 using the selected particular application's extended AID value. The contactless multiplexer 356 can subsequently route NFC communication for the NFC reader 302 to the selected particular application in the appropriate secure processor (e.g., to the SE 308 or to a particular eSIM profile in the eUICC 108).

In some embodiments, a geographic location or area can be associated with an application, such as at first use of the application on the wireless device 102 and/or by configuration of the application by a user of the wireless device 102. An exemplary application type that uses NFC communication is a transit application. In some embodiments, authorization credentials for use of a transit application can be pre-stored and available for “express mode” use, without requiring the user to provide additional authentication (i.e., no user input required once express mode is set up for the transit application). In some embodiments, only one AID value can be enabled for express mode at a given time, and a wireless device 102 can include multiple applications across multiple secure processors that use the same AID value. In some embodiments, rules for use of an application can be established when installing the application on the wireless device 102. In some embodiments, rules for usage of the application may not be available at installation. For example, a user can install a transit application while at home or while traveling but intend the transit application for use only in particular locations (at particular stations or on particular services) or within a particular geographic area (e.g., a city or county or metro area). In some embodiments, upon first use of a transit application, a user can be queried regarding use of express mode for the application, and one or more usage rules can be determined and stored for subsequent referral to determine whether to enable express mode for the transit application at a particular location or within a geographic region. When express mode is enabled, the contactless multiplexer 356 can be informed of the express mode designation as to which application should be used for NFC communication when a transit application is identified by an AID value received from the NFC reader 302. In some embodiments, an AP 310 of a wireless device 102 can proactively inform a contactless multiplexer 356 of the wireless device 102 to use a particular application associated with an AID value, where the particular application can be uniquely identified based on an extended AID value that includes an indication of a secure processor of the wireless device 102 (and an eSIM profile 208 identifier such as an ICCID value when the particular application is resident on an eUICC 108 of the wireless device 102). The AP 310 can determine which particular application to designate to the contactless multiplexer 356 based on a current location of the wireless device 102. When the current location of the wireless device 102 changes, the AP 310 can update the contactless multiplexer 356 to preload a different particular application to use without requiring the contactless multiplexer 356 to request resolution of an ambiguity.

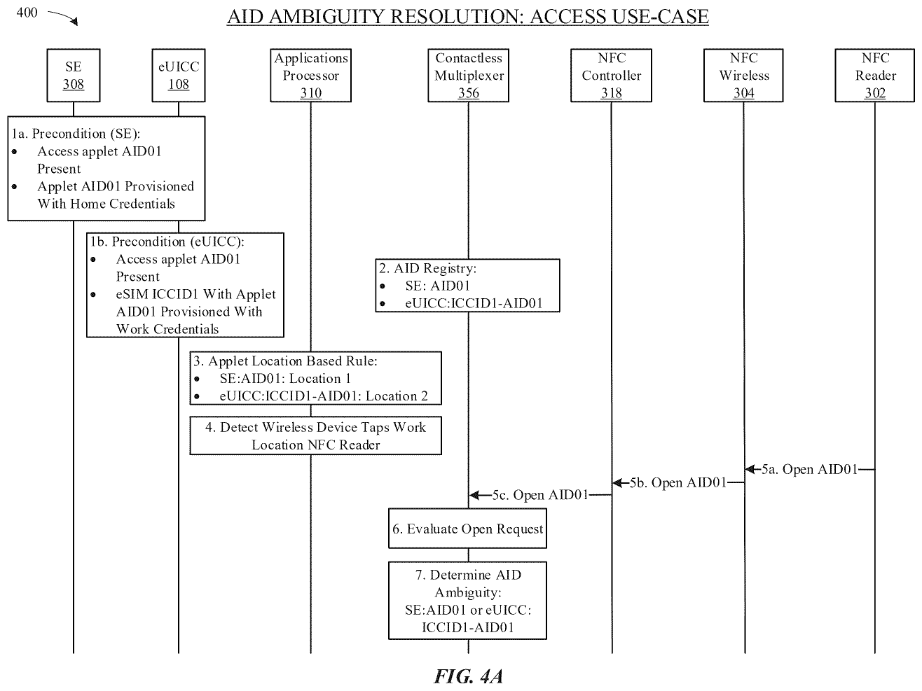

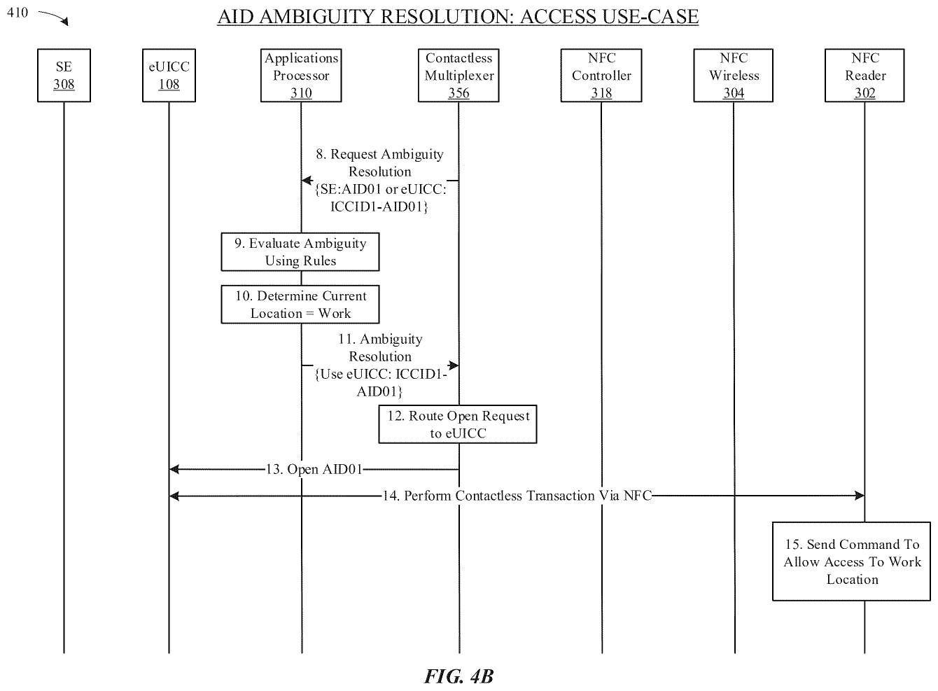

FIGS. 4A and 4B illustrate diagrams 400, 410 of an exemplary set of actions taken by elements of a wireless device 102 to resolve an AID ambiguity for an access use-case. As a first pre-condition, at 1a, the SE 308 of the wireless device 102 can include an access application (applet) identified by an AID value of AID01 and provisioned with credentials for access to a home location (e.g., to a house, apartment building, or condominium). As a second pre-condition, at 1b, the eUICC 108 of the wireless device 102 can include an access application (applet) also identified by the AID value of AID01 included in an eSIM profile 208 identified by an ICCID value of ICCID01. The access application in the ICCID01 eSIM profile 208 can be provided with credentials for access to a work location. At 2, a contactless multiplexer 356 of the wireless device 102, which can be resident in an NFC processor 316 in some embodiments, can be configured with an AID registry 358 that maintains unique (extended) AID values for one or more applications resident on one or more secure processors, e.g., an SE 308 and an eUICC 108, of the wireless device 102. In the example of FIG. 4A, the AID registry 358 includes an entry SE:AID01 for an application having an AID value of AID01 on the SE 308 and a second entry eUICC:ICCID1-AID01, for an application having an AID value on the eUICC 108 included in an eSIM profile 208 having an ICCID value of ICCID1. At 3, an AP 310 of the wireless device 102 includes one or more AID rules 360, e.g., an application (applet) location based rule that indicates the application uniquely identified by the extended AID value SE:AID01 is to be used (preferentially) at a first location, location 1, and also that indicates the application uniquely identified by the extended AID value eUICC:ICCID1-AID01 is to be used (preferentially) at a second location, location 2. At 4, the AP 310 detects the wireless device 102 taps an NFC reader 302 at a work location. At 5a, the NFC reader 302 sends a message to the wireless device 102 to open an application associated with the AID value AID01. At 5b, the message from the NFC reader 302 is communicated via NFC wireless circuitry 304 to an NFC controller 318, which can be resident on an NFC processor 316 of the wireless device 102, in some embodiments. At 5c, the NFC controller 318 passes the message from the NFC reader 302 to the contactless multiplexer 356, which evaluates, at 6, the open application request from the NFC reader 302. At 7, the contactless multiplexer 356 determines there is an AID ambiguity as to which application the NFC reader 302 is requesting to open, as there are multiple applications on the wireless device 102 associated with the AID value of AID01.

Continuing in FIG. 4B, at 8, the contactless multiplexer 356 sends a message to the AP 310 requesting a resolution of the ambiguity as to which particular application to use, the message including unique extended AID values for the first application SE:AID01 and for the second application eUICC:ICCID1-AID01. At 9, the AP 310 evaluates the ambiguity using one or more of the AID rules 360. In some embodiments, the AID rules include logic based on location information, such as indicated at 3 previously. At 10, the AP 310 determines that the wireless device 102 is operating at a current geographic location that corresponds to a work location, which can be associated with a particular application, e.g., the application identified by the extended AID value eUICC:ICCID1-AID01. The AP 310 can determine that the application identified by the extended AID value eUICC:ICCID1-AID01 should be used at the current (work) location and can send to the contactless multiplexer 356, at 11, a response message that resolves the ambiguity. The response message to the contactless multiplexer can include an indication of the particular application to use identified by the particular applications extended AID value, e.g., the extended AID value eUICC:ICCID1-AID01. The contactless multiplexer 356, at 12, can route the open request message from the NFC reader 302 appropriately to the eUICC 108, and send the open request message at 13 to the eUICC 108. At 14, the eUICC 108 and the NFC reader 302 can perform a contactless transaction via NFC communication. The contactless transaction can include credentials or indicate authorization for access at the current (work) location. At 15, the NFC reader 302 can send a command to associated hardware to allow access to the current (work) location.

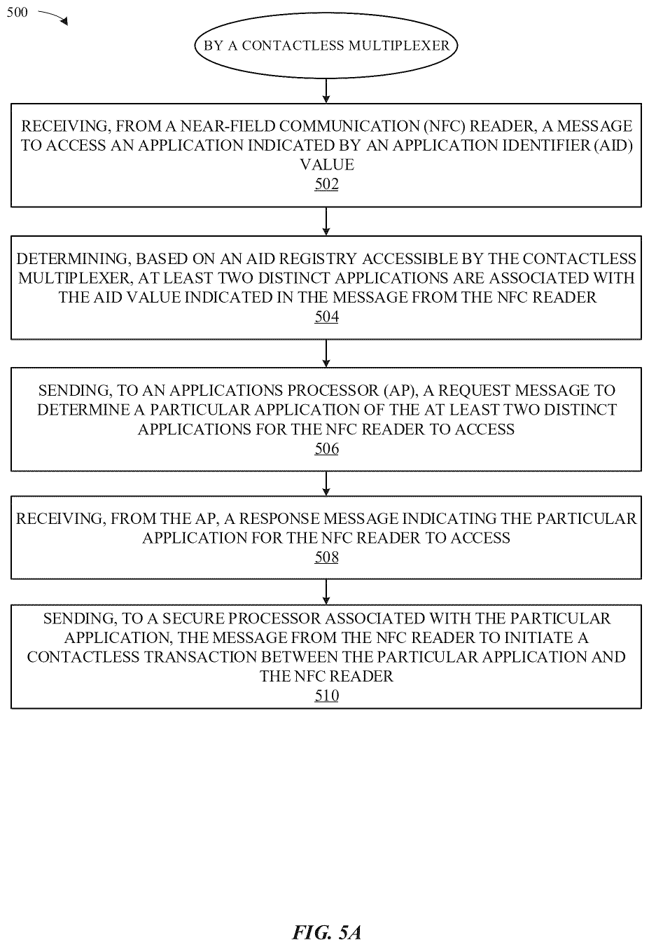

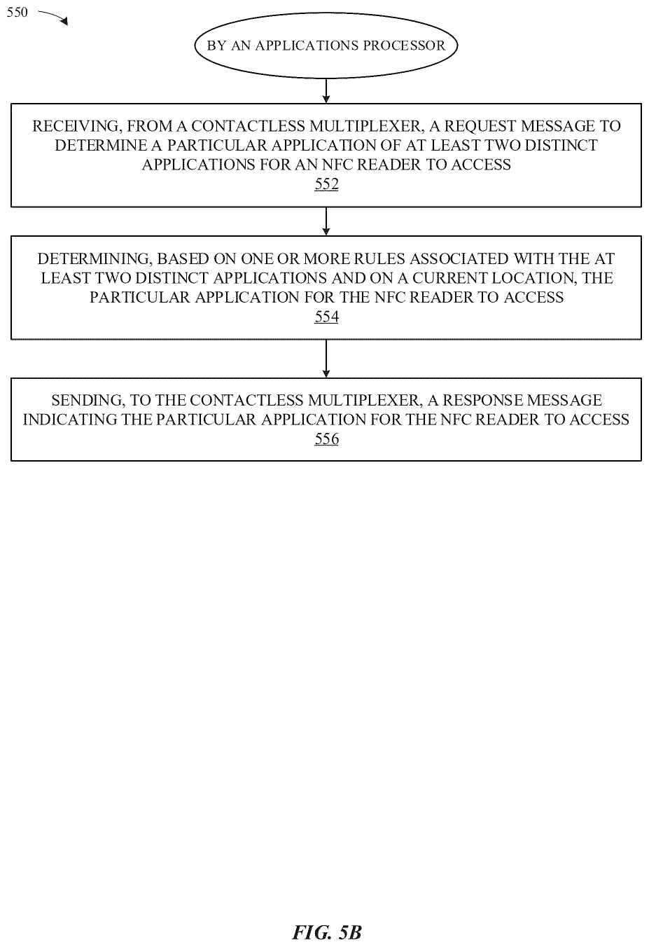

FIG. 5A illustrates a flowchart 500 of an exemplary method to resolve an AID ambiguity by a contactless multiplexer 356. In some embodiments, the contactless multiplexer 356 is included in a wireless device 102. At 502, the contactless multiplexer 356 receives, from an external NFC reader 302, a message to access an application indicated by an AID value in the message. At 504, the contactless multiplexer 356 determines, based on an AID registry 358 accessible by the contactless multiplexer 356, that at least two distinct applications of the wireless device 102 are associated with the AID value indicated by the NFC reader in the message. At 506, the contactless multiplexer 356, sends, to an AP 310, a request message to determine a particular application of the at least two distinct applications for the NFC reader 302 to access. In some embodiments, the AP 310 is included in the wireless device 102. At 508, the contactless multiplexer 356 receives, from the AP 310, a response message indicating the particular application for the NFC reader 302 to access. At 510, the contactless multiplexer 356 sends, to a secure processor associated with the particular application, the message from the NFC reader 302 to initiate a contactless transaction between the particular application and the NFC reader 302. In some embodiments, the particular application is identified by an identifier for a secure processor on which the application resides. In some embodiments, the particular application is identified by an identifier for an eSIM profile 208 in which the application resides. In some embodiments, the particular application is further determine based on a current location. In some embodiments, the AID registry 358 includes one or more AID values associated with one or more applications installed in one or more secure processors. In some embodiments, the AID registry 358 further includes, for at least one AID value of the one or more AID values, additional logical data. In some embodiments, the additional logical data can be used to assist with resolving to which application to route one or more messages received from the NFC reader 302. In some embodiments, the additional logical data includes an indication, for each application of the at least two distinct applications, on which secure processor of the one or more secure processors the associated application resides. In some embodiments, the additional logical data for the AID value includes a unique identifier for an eSIM 208 profile in which the associated application resides. In some embodiments, the AID registry 358 includes AID values for one or more applications usable with NFC communication with the NFC reader 302. In some embodiments, the AID registry 358 includes information for determining a target application to initiate to participate in an NFC transaction.

FIG. 5B illustrates a flowchart 550 of an exemplary method to resolve an AID ambiguity by an AP 310. In some embodiments, the AP 310 is included in a wireless device 102. At 552, the AP 310 receives, from a contactless multiplexer 356, a request message to determine a particular application of at least two distinct applications for an NFC reader 302 to access. In some embodiments, the contactless multiplexer 356 is included in the wireless device 102. At 554, the AP 310, determines based on one or more rules associated with the at least two distinct applications and a current location, the particular application for the NFC reader 302 to access. At 556, the AP 310 sends, to the contactless multiplexer 356, a response message indicating the particular application for the NFC reader to access. In some embodiments, the AP 310 maintains a set of rules to use for resolving ambiguity of which application to use. In some embodiments, the set of rules include associations between particular applications and particular geographic locations. In some embodiments, the particular application is associated with use at a work location. In some embodiments, the particular application is associated with use at a home location. In some embodiments, the particular application is associated with use in a town, city, county, zip code, or metropolitan area.

### Representative Device

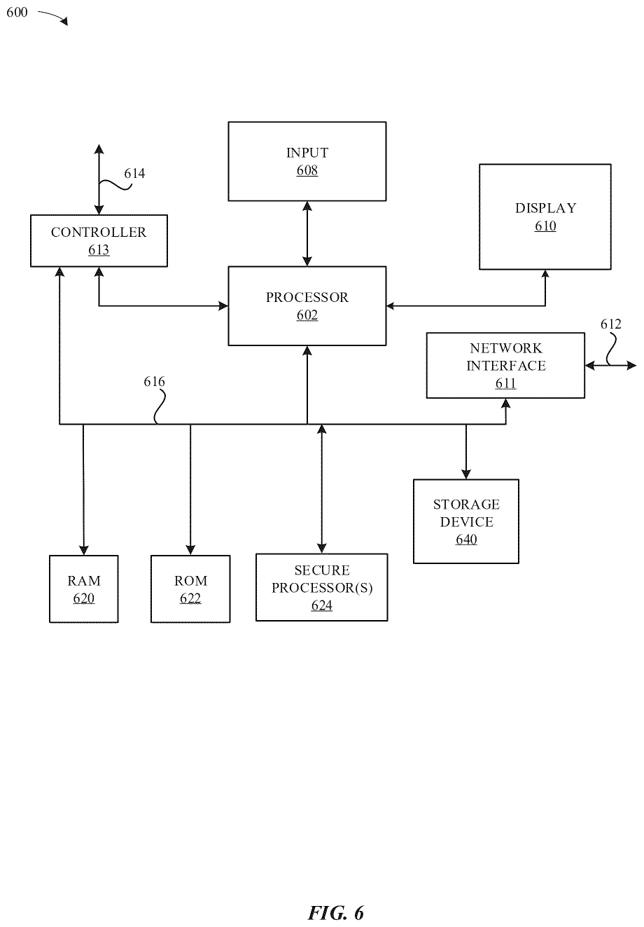

FIG. 6 illustrates a detailed view of a representative computing device 600 that can be used to implement various methods described herein, according to some embodiments. In particular, the detailed view illustrates various components that can be included in the wireless device 102. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that communicatively couples to a data link 612. In the case of a wireless connection, the network/bus interface 611 can include a wireless transceiver.

The computing device 600 also includes a storage device 640, which can include a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600. The computing device 600 can further include one or more secure processors 624, such as a secure element (SE) 308 and/or an eUICC 108.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for ambiguity resolution for access to a particular application, the method comprising:
by a contactless multiplexer:
receiving, from a near-field communication (NFC) reader, a message to access an application indicated by an application identifier (AID) value;
determining, based on an AID registry accessible by the contactless multiplexer, at least two distinct applications are associated with the AID value indicated in the message from the NFC reader;
sending, to an applications processor (AP), a request message to determine a particular application of the at least two distinct applications for the NFC reader to access;
receiving, from the AP, a response message indicating the particular application for the NFC reader to access; and
sending, to a secure processor associated with the particular application, the message from the NFC reader to initiate a contactless transaction between the particular application and the NFC reader.

2. The method of claim 1, wherein the particular application is identified by an identifier for a secure processor on which the application resides.

3. The method of claim 1, wherein the particular application is identified by an identifier for an electronic subscriber identity module (eSIM) profile in which the application resides.

4. The method of claim 1, wherein the particular application is further determined based on a current location.

5. The method of claim 1, wherein the AID registry includes one or more AID values associated with one or more applications installed in one or more secure processors.

6. The method of claim 5, wherein the AID registry further includes, for at least one AID value of the one or more AID values, additional logical data.

7. The method of claim 6, wherein the additional logical data comprises an indication, for each application of the at least two distinct applications, on which secure processor of the one or more secure processors the associated application resides.

8. The method of claim 7, wherein the additional logical data for the AID value comprises a unique identifier for an electronic subscriber identity module (eSIM) profile in which the associated application resides.

9. The method of claim 1, wherein the AID registry comprises AID values for one or more applications usable with NFC communication with the NFC reader.

10. The method of claim 1, wherein the AID registry comprises information for determining a target application to initiate to participate in an NFC transaction.

11. A method for ambiguity resolution for access to a particular application, the method comprising, the method comprising:
by an applications processor (AP):
receiving, from a contactless multiplexer, a request message to determine a particular application of at least two distinct applications for an NFC reader to access;
determining, based on one or more rules associated with the at least two distinct applications and on a current location, the particular application for the NFC reader to access; and
sending, to the contactless multiplexer, a response message indicating the particular application for the NFC reader to access.

12. The method of claim 11, wherein the AP maintains a set of rules to select which application from a plurality of applications to allow the NFC reader to access.

13. The method of claim 12, wherein the set of rules include one or more associations between particular applications and particular geographic locations.

14. The method of claim 13, wherein the particular application is associated with use at a work location.

15. The method of claim 13, wherein the particular application is associated with use at a home location.

16. The method of claim 13, wherein the particular application is associated with use in a town, city, county, zip code, or metropolitan area.

17. A contactless multiplexer comprising at least one processor configured to:
receive, from an external near-field communication (NFC) reader, a message to access an application indicated by an application identifier (AID) value;
determine, based on an AID registry accessible by the contactless multiplexer, at least two distinct applications that are associated with the AID value indicated in the message from the NFC reader;
send, to an applications processor (AP), a request message to determine a particular application of the at least two distinct applications for the NFC reader to access;
receive, from the AP, a response message indicating the particular application for the NFC reader to access; and
send, to a secure processor associated with the particular application, the message from the NFC reader to initiate a contactless transaction between the particular application and the NFC reader.

18. The contactless multiplexer of claim 17, wherein the particular application is identified by an identifier for a secure processor on which the application resides.

19. The contactless multiplexer of claim 17, wherein the particular application is identified by an identifier for an electronic subscriber identity module (eSIM) profile in which the application resides.

20. The contactless multiplexer of claim 17, wherein the particular application is further determined based on a current location.
